(19) United States
(12) Patent Application Publication
(10) Pub. No.: US 2013/0313321 A1
(43) Pub. Date: Nov. 28, 2013

(54) RADIO FREQUENCY IDENTIFICATION READER PAD

(71) Applicant: MEGACOM LIMITED, Hong Kong (HK)

(72) Inventor: Chun Sing Matthew MAN, Hong Kong (HK)

(73) Assignee: Megacom Limited, Hong Kong (HK)

(21) Appl. No.: 13/831,836

(22) Filed: Mar. 15, 2013

Related U.S. Application Data
(63) Continuation of application No. PCT/CN2012/076008, filed on May 24, 2012.

(51) Int. Cl. G06K 7/10

(52) U.S. Cl. CPC G06K 7/10128; G06K 7/10356
USPC 235/439

(57) ABSTRACT

A RFID reader pad includes at least an embedded antenna; a RFID reader module that includes at least a physical port, the RFID reader module being connected to the at least one embedded antenna through the at least one physical port; a micro-controller module connected to the RFID reader module; and a wireless communication module connected to the micro-controller module. The micro-controller module is configured to receive data from the RFID reader module and transmit the data through the wireless communication module. A RFID reader pad network that includes a plurality of the RFID reader pads is also provided.

### CROSS-REFERENCE TO RELATED APPLICATIONS

This application is a Continuation Application of prior PCT application No. PCT/CN2012/076008 filed on May 24, 2012, which claims priority of U.S. provisional application No. 61/489,696, filed on May 25, 2011; the entire contents of which are hereby incorporated by reference.

### FIELD OF THE PATENT APPLICATION

The present patent application generally relates to radio frequency identification (RFID) technologies and more specifically to a radio frequency identification (RFID) reader pad.

### BACKGROUND

RFID systems are being utilized in a great quantity in a multitude of applications. One of the common areas for RFID implementation is product identification, for inventory or for sales. The bar code scanner technology is slowly being replaced by RFID technology. In the simplest of applications, a passive RFID transponder, commonly called a tag or a card, is placed on an object that is to be identified. A RFID reader is then used to obtain information from the tag. The reader, being powered by a power source, typically has a transceiver to transmit and receive signals. The tag also has a transceiver to receive the signal from the reader and to transmit a response back to the reader. The tag is generally passive and powered by the induced electromagnetic field.

The reader is powered and generates a magnetic field from its antenna. When the reader and the tag are within close proximity of each other, the reader generated magnetic field is induced into the tag. The tag uses this coupled energy to power its circuitry. The reader transmits an interrogating signal to the tag, and in response the tag transmits a signal back to the reader. The tag may be placed on an item and the response from the tag may be used to simply identify the item.

RFID systems may use active tags which carry their own source of power such as a battery, or passive tags which contain no source of power and instead rely entirely on energy radiated by the reader unit. Passive tag readers continually or periodically search for the presence of passive tags in the vicinity of the reader by transmitting energy which will activate any tag present. A passive tag does not announce its presence unless activated by the reader.

### SUMMARY

The present patent application is directed to a RFID reader pad. In one aspect, the RFID reader pad includes at least an embedded antenna; a RFID reader module that includes at least a physical port, the RFID reader module being connected to the at least one embedded antenna through the at least one physical port; a micro-controller module connected to the RFID reader module; and a wireless communication module connected to the micro-controller module. The micro-controller module is configured to receive data from the RFID reader module and transmit the data through the wireless communication module.

The RFID reader pad may further include a network module connected to the micro-controller module. The micro-controller module may be configured to receive data from the RFID reader module and transmit the data through the network module.

The wireless communication module may be a WiFi module. The network module may be configured to establish communication based on TCP/IP protocol and through a LAN cable. The RFID reader module may be configured to receive a command from the network module and the micro-controller module through a LAN cable or from the wireless communication module and the micro-controller module through a WiFi connection. The micro-controller module may be configured to provide a UART to TCP/IP interface for data communication.

The RFID reader module may include a plurality of physical ports. Each physical port may be connected to an antenna. The micro-controller module may be configured to start to scan the physical ports when network and power cables are connected to the RFID reader pad.

The micro-controller module may be configured to check whether a physical port that is being scanned is an operable port or the last port in a queue. If the physical port is an operable port, the micro-controller module may be configured to utilize the physical port by interrogating any tags through the antenna connected to the physical port and processing any data received by the antenna. If the physical port is the last operable port, the micro-controller module may be configured to scan the first port in the queue.

The RFID reader module may include an additional physical port and the addition physical port is configured for connecting the RFID reader module and an external antenna.

The micro-controller module may include a processor and a non-volatile data memory. The processor may be configured to monitor any changes in the detection of RFID tags in an area proximate to the RFID reader module relative to a prior interrogation of the RFID reader module. The processor may be configured to adjust the physical port of the RFID reader module to establish a RF communication between the RFID reader module and the RFID tags.

In another aspect, the present patent application provides a RFID reader pad network. The RFID reader pad network includes a plurality of RFID reader pads and a backend processing unit connected to the RFID reader pads. Each RFID reader pad includes: at least an embedded antenna; a RFID reader module with at least a physical port, the RFID reader module being connected to the at least one embedded antenna through the at least one physical port; a micro-controller module connected to the RFID reader module; and a wireless communication module connected to the micro-controller module. The micro-controller module is configured to receive data from the RFID reader module and transmit the data through the wireless communication module.

The RFID reader pads may be connected with each other and with the backend processing unit through LAN or WiFi connections. The RFID reader pads may be configured to transmit data to the backend processing unit for further processing.

In yet another aspect, the RFID reader pad includes a plurality of embedded antennas; a RFID reader module that includes a plurality of physical ports, the RFID reader module being connected to the embedded antennas through the physical ports; a micro-controller module connected to the RFID reader module; and a wireless communication module connected to the micro-controller module. The micro-controller module is configured to receive data from the RFID reader module and transmit the data through the wireless communication module, and configured to receive a command from the wireless communication module and transmit the command to the RFID reader module.

The RFID reader pad may further include a network module connected to the micro-controller module. The micro-controller module may be configured to receive data from the RFID reader module and transmit the data through the network module, and configured to receive a command from the network module and transmit the command to the RFID reader module.

The RFID reader module may include an additional physical port and the addition physical port may be configured for connecting the RFID reader module and an external antenna.

### BRIEF DESCRIPTIONS OF THE DRAWINGS

FIG. 1 illustrates a block diagram of a RFID reader pad according to an embodiment of the present patent application.

FIG. 2 is an exterior view of the RFID reader pad illustrated in FIG. 1.

FIG. 3A shows a schematic circuit diagram for the UHF RFID reader module and the micro-controller module.

FIG. 3B shows a schematic circuit diagram for a LED controller.

FIG. 4 is a block diagram illustrating an interface board for the RFID reader module depicted in FIG. 1.

FIG. 5 is a flow chart of the operation mechanism of the RFID reader pad illustrated in FIG. 1.

FIG. 6 illustrates how multiple RFID reader pads are connected over a network to form an RFID reader pad system according to another embodiment of the present patent application.

### DETAILED DESCRIPTION

Reference will now be made in detail to a preferred embodiment of the RFID reader pad disclosed in the present patent application, examples of which are also provided in the following description. Exemplary embodiments of the RFID reader pad disclosed in the present patent application are described in detail, although it will be apparent to those skilled in the relevant art that some features that are not particularly important to an understanding of the RFID reader pad may not be shown for the sake of clarity.

Furthermore, it should be understood that the RFID reader pad disclosed in the present patent application is not limited to the precise embodiments described below and that various changes and modifications thereof may be effected by one skilled in the art without departing from the spirit or scope of the protection. For example, elements and/or features of different illustrative embodiments may be combined with each other and/or substituted for each other within the scope of this disclosure.

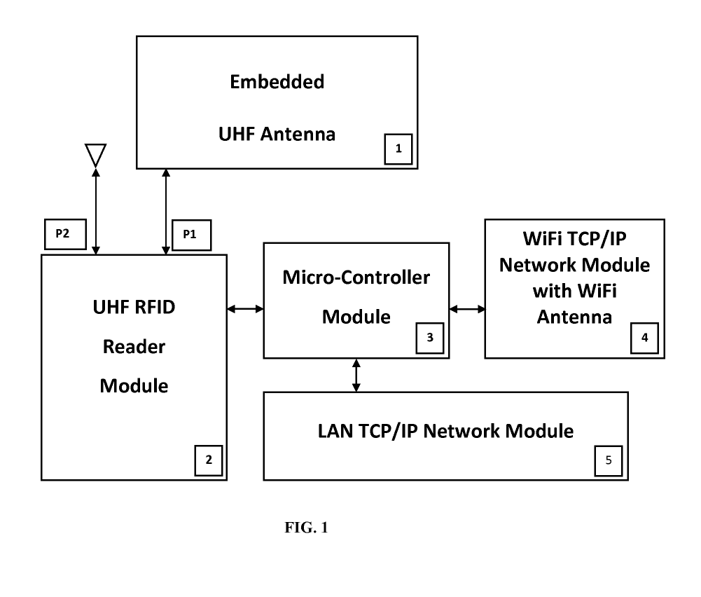

FIG. 1 illustrates a block diagram of a RFID reader pad according to an embodiment of the present patent application. The RFID reader pad includes a UHF RFID antenna 1, a UHF RFID reader module 2, a micro-controller module 3, a WiFi TCP/IP network module 4, and a LAN TCP/IP network module 5. The UHF RFID antenna 1 is connected to a physical port 1 (P1) of the UHF RFID reader module 2. An external UHF RFID antenna can be connected to a physical port 2 (P2) of the UHF RFID reader module 2. The connected antennas are configured to detect a context of any RFID tags in response to interrogation by the RFID reader pad. The programmable micro-controller module 3 controls the UHF RFID reader module 2 on the read cycle. In response to the tag's information feedback, the UHF RFID reader module 2 is configured to query the tags in air so as to send the tag information back to the micro-controller module 3. As a result, information of the RFID tags captured by the UHF RFID reader module 2, controlled by the micro-controller module 3, is communicated to an external device through a communication link based on a compromised data exchange protocol. The data is sent through either the LAN TCP/IP network module 5 or the WiFi TCP/IP network module 4 wirelessly. It is noted that the micro-controller module 3 in this embodiment includes at least a processor and a non-volatile data memory. It is understood that the module 5 is configured to establish communication based on TCP/IP protocol through a wired LAN cable, and the WiFi TCP/IP network module 4 is configured to establish communication through the standard WiFi TCP/IP protocol. It is further noted that the RFID reader module 2 may include a plurality of physical ports, wherein each physical port may be connected to an embedded antenna or an external antenna.

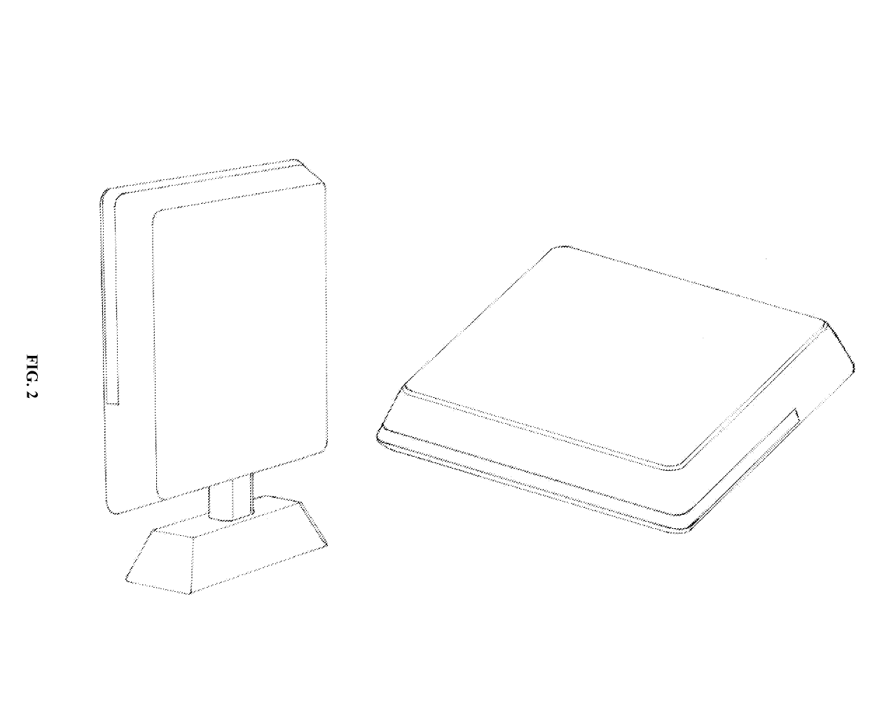

FIG. 2 is an exterior view of the RFID reader pad illustrated in FIG. 1. The RFID reader pad is designed as a packed device with embedded UHF RFID antenna and WiFi or LAN connectivity. The UHF RFID reader pad is configured to detect any RFID tags in an area proximate to the device in response to interrogations by the RFID reader pad. At least one processor included in the micro-controller module 3 is configured to monitor any changes in the detection of the RFID tags in the area proximate to the device relative to a prior interrogation to determine whether the data of the device has changed. The at least one processor is configured to adjust the antenna ports of the UHF RFID reader module 2 to establish a RF communication between the RFID reader module 2 and the RFID tags. The illustrated embodiment is designed for the RFID reader module by microelectronics technology with compliance to EPC GEN2, IS018000-6C.

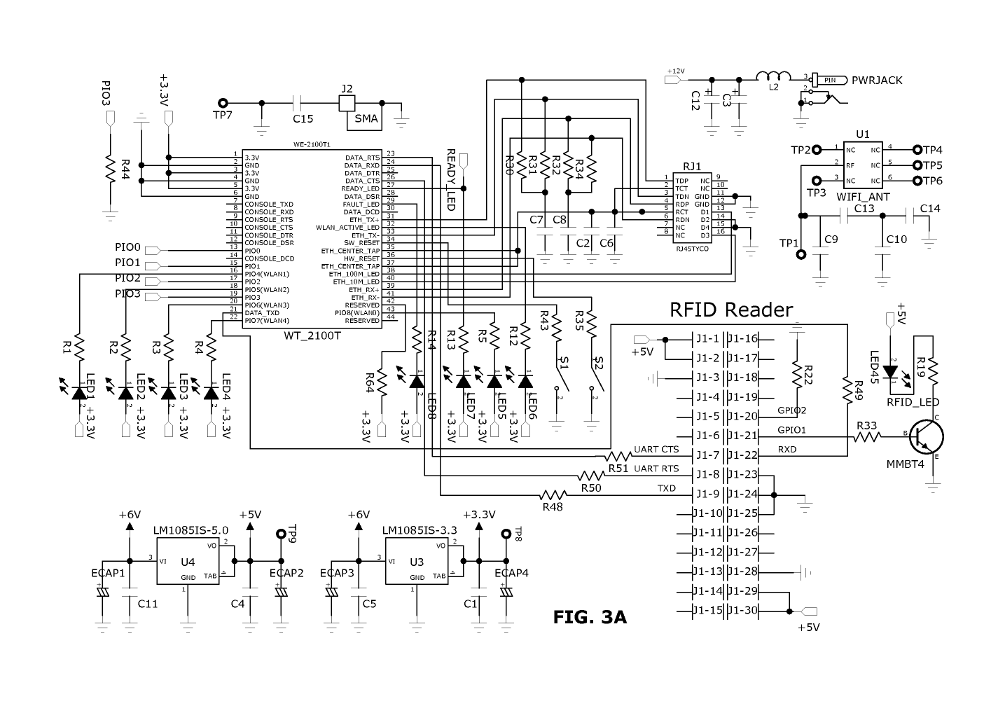

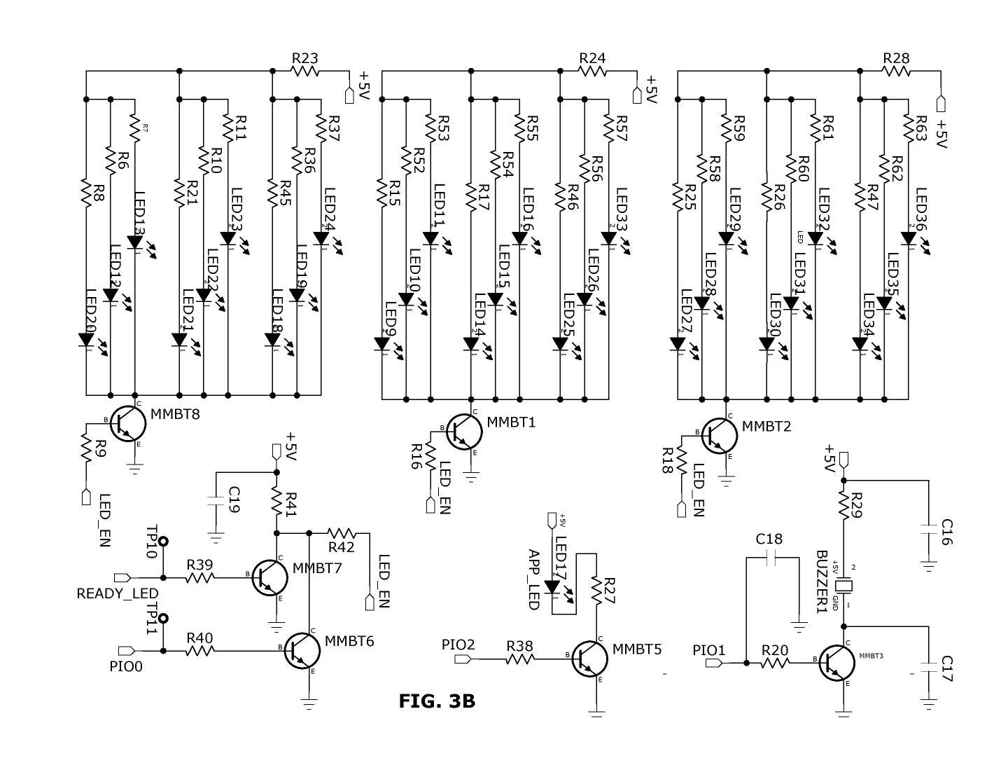

FIGS. 3A-3B are schematic circuit diagrams of the RFID reader pad illustrated in FIG. 1. FIG. 3B shows a schematic circuit diagram for a LED controller. The controlling signal is transmitted from the micro-controller module 3. The data will be directly transferred to the micro-controller module 3. FIG. 3A shows a schematic circuit diagram for the UHF RFID reader module 2 and the micro-controller module 3. The circuit handles and regulates the data flow between the UHF RFID reader module 2, the LEDs and the antenna ports to antennas. The power driving this circuit is provided by the power cable. The reader module 2 receives commands from the network module 5 and the micro-controller module 3 through a LAN cable, or from the WiFi module 4 and the micro-controller module 3 through a WiFi connection.

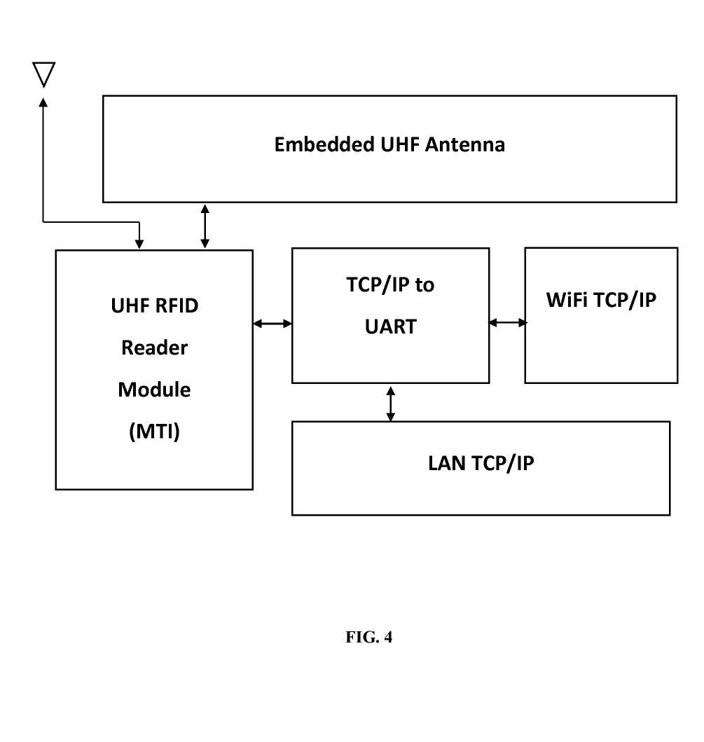

FIG. 4 is a block diagram illustrating an interface board for the RFID reader module 2 depicted in FIG. 1. It shows the circuit operation principle of the RFID reader. For the UHF RFID reader module 2, it requires the micro-controller 3 to provide a UART to TCP/IP interface for data communication. The data is sent through either the LAN TCP/IP network module 5 or the WiFi network module 4 wirelessly.

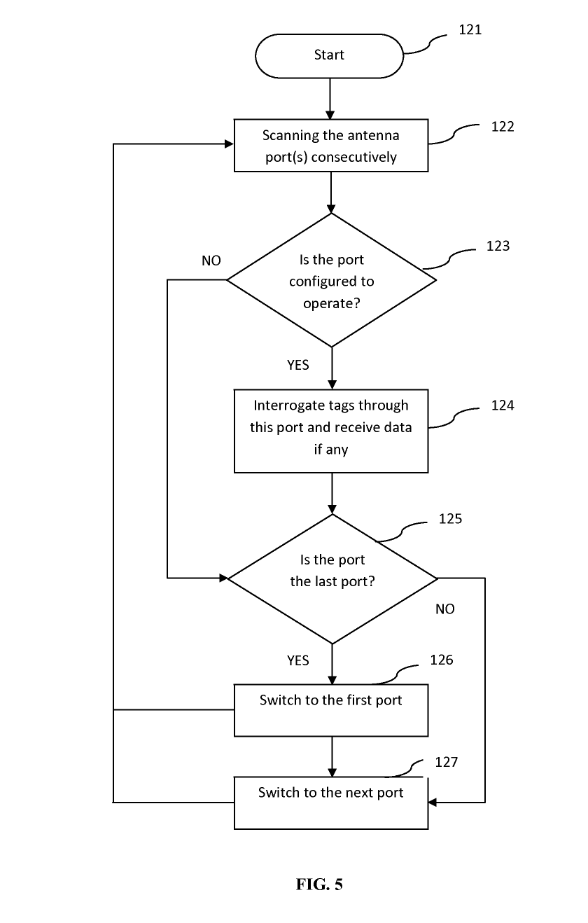

FIG. 5 is a flow chart of the operation mechanism of the RFID reader pad illustrated in FIG. 1. Referring to FIG. 5, when network and power cables are connected to the RFID reader pad, the RF reader pad starts its processing. The RFID reader pad will then start scanning and processing signals at each antenna port consecutively (Step 122). The RFID reader pad will check if the port is configured as an operable port, i.e. whether the port is ready to be used by the RFID reader (Step 123). If the antenna port is an operable port, the RFID reader will utilize the port by interrogating any tags through an antenna connected to the port, and processing any data received by the antenna through the antenna port (Step 124). Afterwards, the antenna port will be checked if it is the last operable port of the RFID reader in the scanning queue (Step 125). If the port is not an operable one in Step 123, the processing flow goes directly to check if it is the last operable port in the scanning queue (Step 125). If the current port is the last operable port, the processing flow will switch to scanning the first port (Step 126) and loop back to the port scanning of Step 122. If it is not the last configured operable port in Step 125, then the processing flow will switch to scanning the next port of the RFID reader (Step 127). The above-mentioned process is executed by the micro-controller module 3 and goes on until power supplied to the RFID reader pad is interrupted (for example when the network connection of the RFID reader pad is lost or when the power cable is not connected).

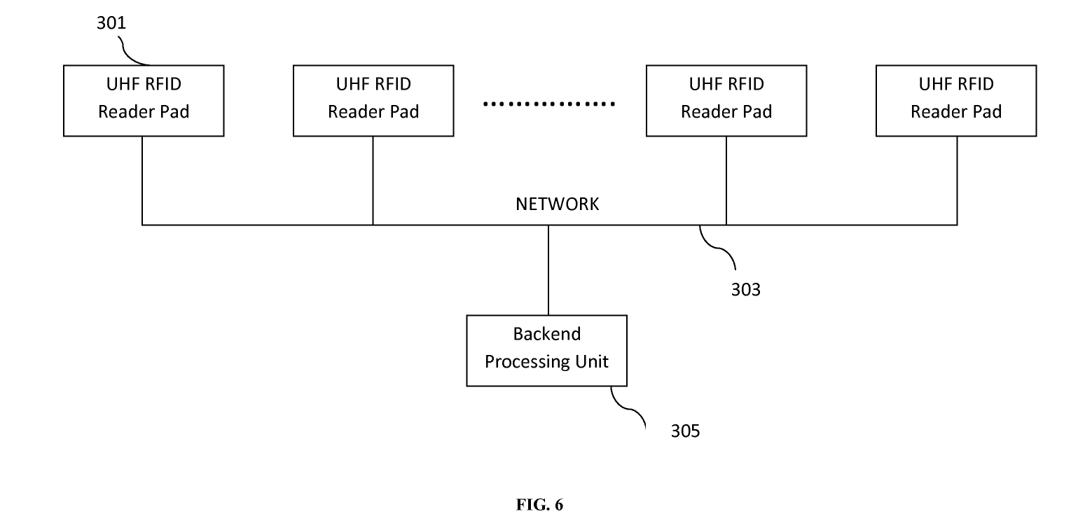

FIG. 6 illustrates how multiple RFID reader pads are connected over a network to form an RFID reader pad system according to another embodiment of the present patent application. Referring to FIG. 6, multiple RFID reader pads 301 are connected to network 303 either by LAN or WiFi (WLAN) and become multiple network access points on the network 303. Thus, the RFID reader pads 301 on the same network 303 form a network of access points for UHF RFID tag interrogation. Each RFID reader pad 301 operates as described above and the received data is sent back to a backend processing unit 305 for further processing. It is understood that by cascading the RFID readers 301 through a network, the number of antenna ports and reader pads can be increased dramatically under this architecture.

The above embodiments of the present patent application provide a compact ultra-high frequency (UHF) RFID reader pad that includes embedded antenna and one antenna port for external antenna connection within a single device. The RFID reader pad also adopts the WiFi technology so that the connectivity of the device is improved. In addition, the embodiments provide a RFID reader that meets most of the industrial requirements, being highly secure, durable, scalable, and reliable. Moreover, the RFID reader pad is fanless with a slim figure and a compact size to fit most packed, harsh and dusty working environment.

While the present patent application has been shown and described with particular references to a number of embodiments thereof, it should be noted that various other changes or modifications may be made without departing from the scope of the present invention.

What is claimed is:

1. A RFID reader pad comprising:
at least an embedded antenna;
a RFID reader module comprising at least a physical port, the RFID reader module being connected to the at least one embedded antenna through the at least one physical port;
a micro-controller module connected to the RFID reader module; and
a wireless communication module connected to the micro-controller module; wherein:
the micro-controller module is configured to receive data from the RFID reader module and transmit the data through the wireless communication module.

2. The RFID reader pad of claim 1 further comprising a network module connected to the micro-controller module, wherein the micro-controller module is configured to receive data from the RFID reader module and transmit the data through the network module.

3. The RFID reader pad of claim 1, wherein the RFID reader module comprises an additional physical port and the addition physical port is configured for connecting the RFID reader module and an external antenna.

4. The RFID reader pad of claim 1, wherein the micro-controller module comprises a processor and a non-volatile data memory.

5. The RFID reader pad of claim 4, wherein the processor is configured to monitor any changes in the detection of RFID tags in an area proximate to the RFID reader module relative to a prior interrogation of the RFID reader module.

6. The RFID reader pad of claim 4, wherein the processor is configured to adjust the physical port of the RFID reader module to establish a RF communication between the RFID reader module and the RFID tags.

7. The RFID reader pad of claim 2, wherein the wireless communication module is a WiFi module.

8. The RFID reader pad of claim 7, wherein the network module is configured to establish communication based on TCP/IP protocol and through a LAN cable.

9. The RFID reader pad of claim 8, wherein the RFID reader module is configured to receive a command from the network module and the micro-controller module through a LAN cable or from the wireless communication module and the micro-controller module through a WiFi connection.

10. The RFID reader pad of claim 9, wherein the micro-controller module is configured to provide a UART to TCP/IP interface for data communication.

11. The RFID reader pad of claim 2, wherein the RFID reader module comprises a plurality of physical ports, each physical port is connected to an antenna, the micro-controller module is configured to start to scan the physical ports when network and power cables are connected to the RFID reader pad.

12. The RFID reader pad of claim 11, wherein the micro-controller module is configured to check whether a physical port that is being scanned is an operable port or the last port in a queue.

13. The RFID reader pad of claim 12, wherein if the physical port is an operable port, the micro-controller module is configured to utilize the physical port by interrogating any tags through the antenna connected to the physical port and processing any data received by the antenna.

14. The RFID reader pad of claim 13, wherein if the physical port is the last operable port, the micro-controller module is configured to scan the first port in the queue.

15. A RFID reader pad network comprising a plurality of RFID reader pads and a backend processing unit connected to the RFID reader pads, each RFID reader pad comprising:
at least an embedded antenna;
a RFID reader module with at least a physical port, the RFID reader module being connected to the at least one embedded antenna through the at least one physical port;
a micro-controller module connected to the RFID reader module; and
a wireless communication module connected to the micro-controller module; wherein:
the micro-controller module is configured to receive data from the RFID reader module and transmit the data through the wireless communication module.

16. The RFID reader pad network of claim 15, wherein the RFID reader pads are connected with each other and with the backend processing unit through LAN or WiFi connections.

17. The RFID reader pad network of claim 15, wherein the RFID reader pads are configured to transmit data to the backend processing unit for further processing.

18. A RFID reader pad comprising:
a plurality of embedded antennas;
a RFID reader module comprising a plurality of physical ports, the RFID reader module being connected to the embedded antennas through the physical ports;
a micro-controller module connected to the RFID reader module; and
a wireless communication module connected to the micro-controller module; wherein:
the micro-controller module is configured to receive data from the RFID reader module and transmit the data through the wireless communication module, and configured to receive a command from the wireless communication module and transmit the command to the RFID reader module.

19. The RFID reader pad of claim 18 further comprising a network module connected to the micro-controller module, wherein the micro-controller module is configured to receive data from the RFID reader module and transmit the data through the network module, and configured to receive a command from the network module and transmit the command to the RFID reader module.

20. The RFID reader pad of claim 19, wherein the RFID reader module comprises an additional physical port and the addition physical port is configured for connecting the RFID reader module and an external antenna.
